(19) United States
(12) Patent Application Publication
(10) Pub. No.: US 2008/0179067 A1
(43) Pub. Date: Jul. 31, 2008

(54) Central control chemical fire extinguishing system

(76) Inventor: Chia-Chun Ho, Taichung Hsien (TW)

Correspondence Address: CHIA-CHUN HO, 235 Chung - Ho, Box 8-24, Taipei, omitted

(21) Appl. No.: 11/699,841

(22) Filed: Jan. 31, 2007

(51) Int. Cl. A62C 37/00

(52) U.S. Cl. 169/60

(57) ABSTRACT

A central control chemical fire extinguishing system, comprises a main control end; at least one fire alarm control panel which is connected to the main control end or to another fire alarm control panel through a network; at least one monitor module for monitoring different areas and machines; at least one electromagnetic valve connected to the fire alarm control panel and being driven by signals from the fire alarm control panel; and at least one chemical fire extinguisher connected to the electromagnetic valve and being concentrated at one place.

### FIELD OF THE INVENTION

The present invention relates to fire extinguishers, and particularly to a central control chemical fire extinguishing system, wherein the chemical fire extinguishers are concentrated at one placed and the fire extinguishing material is transferred to the place having fire accidents. The monitors of the accidents are performed by a plurality of fire alarm control panel so as to achieve the object of separation of persons and chemical fire extinguishers, and the space of locating the chemical fire extinguishers are saved.

### BACKGROUND OF THE INVENTION

For fire proof, in the prior art, water spray heads are equipped at the ceiling of a plant or a room, fire accident occurs, the water will spray out from the spraying head.

Currently to have well protections to the machines of plants, generally, a chemical fire extinguisher F is equipped beside the machine M, as illustrated in FIG. 1. Thus when fire accident occurs, the person beside the machine can use the chemical fire extinguisher F to extinguish fire so as to reduce the destroy of the machine to a minimum extend and other machine will not be affected. However, CO₂ is filled in the chemical fire extinguisher. If the gas releases out. The operator beside the chemical fire extinguisher will be hurt. Furthermore to place the chemical fire extinguishers beside the machine will occupy a large space and induces the problem in maintenance.

### SUMMARY OF THE INVENTION

Accordingly, the primary object of the present invention is to provide a central control chemical fire extinguishing system, wherein the chemical fire extinguishers are concentrated at one place. A plurality of fire alarm control panels are equipped at places for monitoring fire alarm. A main control end serves to monitor the fire alarm control panel and the conditions of the places (including related machines to be monitored) are transferred back to the main control end and the messages are displayed to the operators. Furthermore the electromagnetic valves will be actuated to the actuate the chemical fire extinguishers. The fire extinguishing materials CO₂ will be transferred to the place occurring fire accidents. Thus by the design of the present invention, the operators and chemical fire extinguishers are separated at different places so as to achieve the object of safety of the machines and persons and the space in the plant is saved.

To achieve above objects, the present invention provides a central control chemical fire extinguishing system which comprises a main control end; at least one fire alarm control panel which is connected to the main control end or to another fire alarm control panel through a network; at least one monitor module for monitoring different areas and machines; at least one electromagnetic valve connected to the fire alarm control panel and being driven by signals from the fire alarm control panel; and at least one chemical fire extinguisher connected to the electromagnetic valve and being concentrated at one place.

The various objects and advantages of the present invention will be more readily understood from the following detailed description when read in conjunction with the appended drawing.

### BRIEF DESCRIPTION OF THE DRAWINGS

FIG. 1 is a schematic view about the prior art fire extinguisher devices.

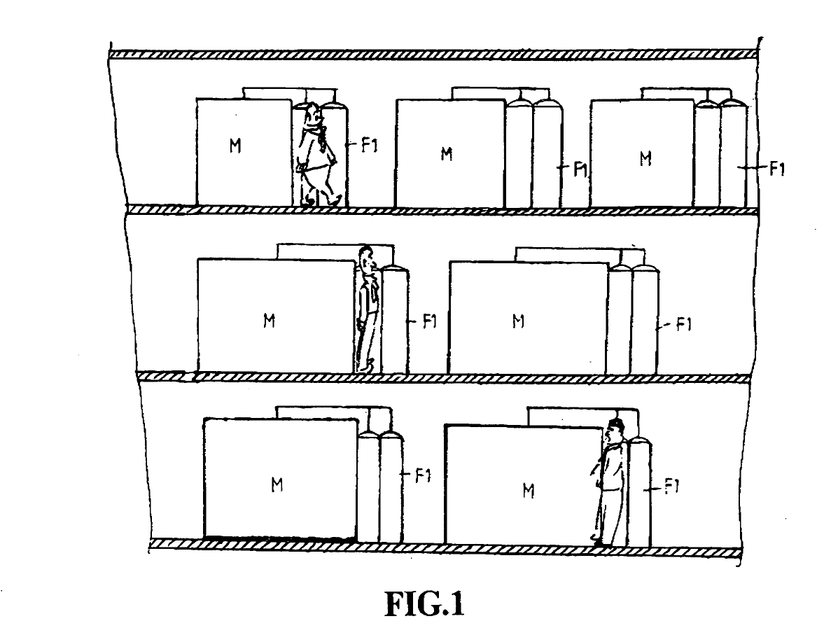

FIG. 2 is a schematic view about the central control chemical fire extinguishing system of the present invention.

FIG. 3 is a block diagram about the central control chemical fire extinguishing system of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

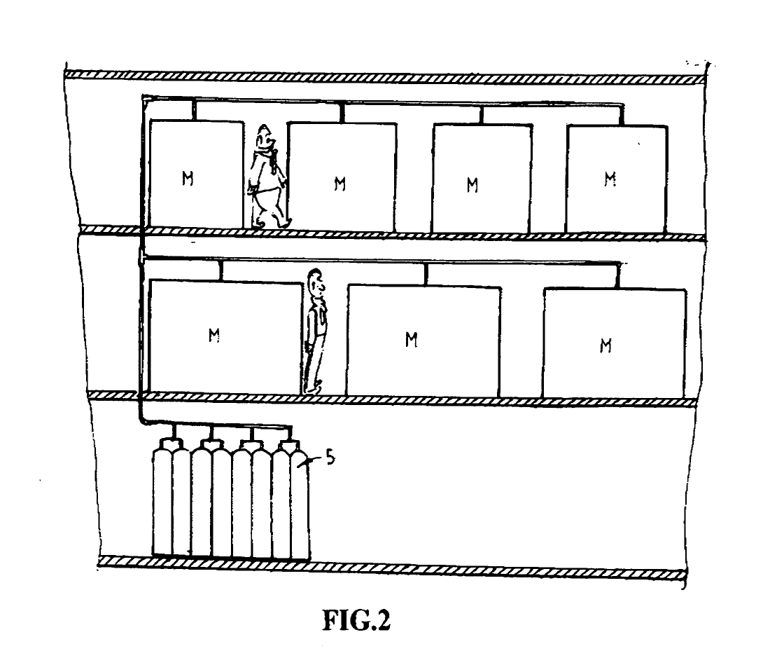

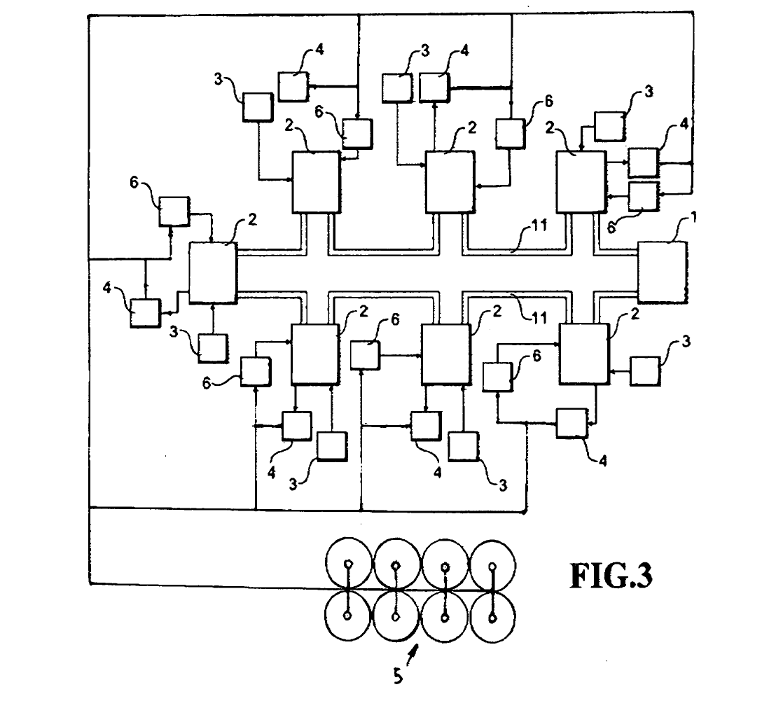

Referring to FIGS. 2 and 3, the schematic view and block diagram of a chemical fire extinguisher for machine table according to the present invention is illustrated. In the present invention, the chemical fire extinguishers are concentrated and arranged at a farther place. The chemical fire extinguishers are monitored through an Internet so that the chemical fire extinguishers at farther place can be monitored and actuated at far places.

In the system of the chemical fire extinguishers according to the present invention includes the devices of a main control end 1, a plurality of fire alarm control panels 2, a plurality of monitor modules 3, a plurality of electromagnetic valves 4, a plurality of chemical fire extinguishers 5 and a plurality of pressure detection devices 6.

The main control end 1 has a computer. The monitor module 3 is connected to each of the fire alarm control panel 2 through Internet and RS-485 transmission interface 11.

The fire alarm control panel 2 is connected to the main control end 1 and a fire alarm control panel 2 of a last stage or a next stage through a network card (not shown) and an RS-485 transmission interface 11 so as to form a fire alarm monitor connection. The fire alarm control panel 2 can be arranged at any stair. The fire alarm control panel 2 has an operation system with a UNICODE technology for supporting Chinese operation frames and module design. At most 10 loops can be arranged. Each loop has branches for supporting ring, non-ring or T connection. Each loop can support a 159 detection and a 159 module. Meanwhile, a branch de-grade operation module is supported. Non-shielding twisting wires are permissible in use. The fire alarm control panel 2 is built with alarm, fault, monitoring and protection relays. Furthermore, the fire alarm control panel 2 can be programmed and circuit card can be inputted or outputted linearly. Thereby the system can be interconnected. The off line programming is allowable. The alpha or numeral-alpha programming design is allowable. The fire alarm control panel 2 has indication lights of restoring, acknowledges, silence, and operation states so that it can be used without using any display. The fire alarm control panel 2 can support VIEW alarm and HARSH bad environment detector or smoke heat compound detectors. The fire alarm control panel 2 is built with setting of different grades of alarm sensitivity. The area is divided into a plurality of fire alarm sections, programmable logic sections, programmable fault sections, gas fire extinguishing control sections.

The monitor module 3 can be arranged to monitor different areas or machines and can be electrically connected to the fire alarm control panel 2. The monitor module 3 has the functions of fire alarm, heat detection, manual switching, buzzing, alarm releasing, area isolation, signal detection, etc., and can transfer detection signals to the fire alarm control panel 2.

The electromagnetic valve 4 is electrically connected to each fire alarm control panel 2 and is driven by the fire alarm control panel 2.

The chemical fire extinguisher 5 is a general steel casing fire extinguisher and is connected to the electromagnetic valve 4. The chemical fire extinguisher 5 is concentrated to the base floor of a building or a farther place. Meanwhile, it is connected to a plurality of transfer tubes. Each tube extends to other floor for monitoring the area of the floor or the related machine. If the above mentioned electromagnetic valve 4 is driven, the chemical components in the fire extinguisher are transferred to the monitoring area or the machine for fir extinguishing.

The pressure detection device 6 is connected to the fire alarm control panel 2 and the chemical fire extinguisher 5. The pressure detection device 6 serves for detecting the internal pressure of the fire extinguisher. The detecting pressure values are transferred to the fire alarm control panel 2 so as to know which chemical fire extinguisher 5 is exhausted.

When the system of the present invention is actuated, the main control end 1 will connect to and set each fire alarm control panels 2 through Internet. Thereby the fire alarm control panels 2 at each floors or machines will actuate the monitor action. Then the detection signals are transferred to the fire alarm control panel 2. For example, if A area has fire alarm by the detection of the monitor module 3, the detection signals are transferred to the fire alarm control panel 2 and the messages are displayed on the fire alarm control panel 2. The fire alarm control panel 2 will display the message of fire alarm and drives the electromagnetic valve 4 to actuate. Then, the chemical fire extinguisher 5 will actuate and the chemical agents in the chemical fire extinguisher 5 is transferred to the A area for extinguishing fire.

When the monitor module 3 are actuated manually and fire alarm occurs, the message will be transferred to the fire alarm control panel 2 for further processing. The display on the fire alarm control panel 2 will display the message and the electromagnetic valve 4 is actuated. Then the chemical fire extinguisher 5 is actuated, and the chemical agents in the fire extinguisher will be transferred to the area for extinguishing fire.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A central control chemical fire extinguishing system, comprising:
a main control end;
at least one fire alarm control panel which is connected to the main control end or to another fire alarm control panel through a network;
at least one monitor module for monitoring different areas and machines;
at least one electromagnetic valve connected to the fire alarm control panel and being driven by signals from the fire alarm control panel; and
at least one chemical fire extinguisher connected to the electromagnetic valve and being concentrated at one place.

2. The central control chemical fire extinguishing system as claimed in claim 1, wherein the main control end is a computer.

3. The central control chemical fire extinguishing system as claimed in claim 1, wherein the main control end is connected to each fire alarm control panel through Internet and RS-485 transmission interface.

4. The central control chemical fire extinguishing system as claimed in claim 1, wherein the fire alarm control panel is connected to the main control end and other fire alarm control panel through Internet and RS-485 transmission interface.

5. The central control chemical fire extinguishing system as claimed in claim 1, wherein the fire alarm control panel has an operation system therein, by UNICODE technology, it supports Chinese operation frames and adapts modularization design.

6. The central control chemical fire extinguishing system as claimed in claim 1, wherein each fire alarm control panel is arranged with at most 10 loops; each loop has branches for supporting ring, non-ring and T connection; and each loop supports 159 detector and 159 module and support a degrading operation module.

7. The central control chemical fire extinguishing system as claimed in claim 1, wherein the fire alarm control panel is built with alarm devices, fault detection devices, monitoring devices, and protection relays.

8. The central control chemical fire extinguishing system as claimed in claim 1, wherein the fire alarm control panel is programmed with a circuit card slot which can be inputted and outputted linearly, and has a function of off-line programming and alpha or numeral-alpha programming.

9. The central control chemical fire extinguishing system as claimed in claim 1, wherein the fire alarm control panel has indication lights of restoring, acknowledges, silence, and operation states so that it can be used without using any display.

10. The central control chemical fire extinguishing system as claimed in claim 1, wherein the fire alarm control panel supports one of a VIEW alarm and a HARSH bad environment detector a and smoke heat compound detectors.

11. The central control chemical fire extinguishing system as claimed in claim 1, wherein the fire alarm control panel is built with setting of different grades of alarm sensitivity.

12. The central control chemical fire extinguishing system as claimed in claim 1, wherein the area is divided into a plurality of fire alarm sections, programmable logic sections, programmable fault sections, gas fire extinguishing control sections.

13. The central control chemical fire extinguishing system as claimed in claim 1, wherein the monitor module has at one function of fire detection, machine fault detection, and heat detection.

14. The central control chemical fire extinguishing system as claimed in claim 1, wherein the monitor module is actuated manually.

15. The central control chemical fire extinguishing system as claimed in claim 1, wherein the monitor module has a buzzer.

16. The central control chemical fire extinguishing system as claimed in claim 1, wherein the monitor module emits fire release signals.

17. The central control chemical fire extinguishing system as claimed in claim 1, wherein the main control end emits machine isolation signals.

18. The central control chemical fire extinguishing system as claimed in claim 1, wherein the chemical fire extinguisher is a steel casing chemical fire extinguisher.

19. The central control chemical fire extinguishing system as claimed in claim 1, wherein the chemical fire extinguisher is connected with a plurality of transfer tubes which extend to different floors and machines.

20. The central control chemical fire extinguishing system as claimed in claim 1, further comprising a pressure detection device which is connected to the fire alarm control panel and chemical fire extinguisher for detecting pressure of an interior of the chemical fire extinguisher.
